(19) United States
(12) Patent Application Publication
(10) Pub. No.: US 2016/0291657 A1
(43) Pub. Date: Oct. 6, 2016

(54) COMPUTER AND METHOD FOR PREVENTING ERROR SHUTDOWN

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventor: ZHONG-GANG WU, Wuhan (CN)

(21) Appl. No.: 14/695,685

(22) Filed: Apr. 24, 2015

(30) Foreign Application Priority Data
Apr. 1, 2015 (CN) 201510151066.5

(51) Int. Cl. G06F 1/26; G06F 1/16

(52) U.S. Cl. CPC G06F 1/26; G06F 1/16

(57) ABSTRACT

A computer includes a power button, a south bridge chip, a switch module, a mode setting module and a control module. The power button transmits a power off signal in response to a power off operation. The south bridge chip controls the computer to shutdown in response to the power off signal. The switch module controls whether the power off signal is transmitted to the south bridge chip. The mode setting module provides modes for setting the mode of the computer. The provided modes include a preventing power off mode. The control module controls the switch module to disconnect to prevent the power off signal from transmitting to the south bridge chip on the basis of the power off signal when the mode of the computer is set as the preventing power off mode. The disclosure also provides a method for preventing error shutdown of the computer.

### CROSS-REFERENCE TO RELATED APPLICATIONS

This application claims priority to Chinese Patent Application No. 201510151066.5, filed on Apr. 1, 2015, the contents of which are incorporated by reference herein.

### FIELD

The subject matter herein relates to computers, especially relates to a computer capable of preventing error shutdown and method for preventing error shutdown of the computer.

### BACKGROUND

Children may press buttons of the computer when the computer is being used, if the power button is pressed the computer will shut down.

### BRIEF DESCRIPTION OF THE DRAWINGS

Implementations of the present technology will now be described, by way of example only, with reference to the attached figures.

FIG. 1 is a block diagram of a computer according to the present disclosure.

FIG. 2 is a flowchart of a method for preventing error shutdown computer according to the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “comprising” means “including, but not necessarily limited to”; it specifically indicates open-ended inclusion or membership in a so-described combination, group, series, and the like.

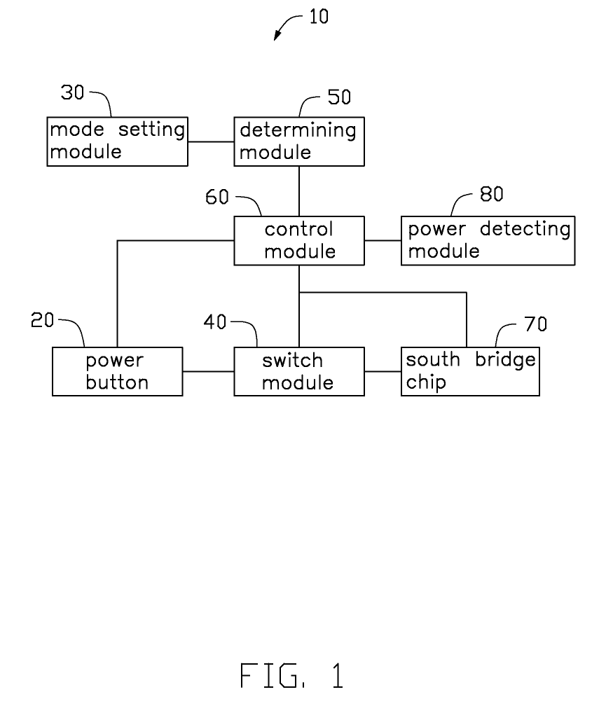

FIG. 1 illustrates a computer 10 includes a power button 20, a mode setting module 30, a switch module 40, a determining module 50, a control module 60 and a south bridge chip 70. In an embodiment, the computer 10 is a notebook computer. The mode setting module 30, the switch module 40, the determining module 50, the control module 60 are programs and at least one of the programs executed a processor (not shown) of the computer 10.

The power button 20 is configured to transmit a power on/power off signal to the switch module 40 and the control module 60 in response to a power on/power off operation on the power button 20. The power on operation is similar to an operation to the computer to start up the computer 10. The power on operation may be a press operation on the power button 20 less than a preset time, for example, two seconds. The power off operation is similar to an operation to the computer to shut down the computer. The power off operation may be a press operation on the power button 20 more than the preset time. The switch module 40 connects between the power button 20 and the south bridge chip 70. The switch module 40 is configured to control whether the power on/power off signal is transmitted to the south bridge chip 70. The south bridge chip 70 is configured to control the computer 10 to start up in response to the power on signal and control the computer 10 to shutdown in response to the power off signal.

The mode setting module 30 is configured to provide modes for a user to set the mode of the computer 10. The mode setting module 30 provides a preventing power off mode and a not preventing mode. The preventing power off mode indicates that the power off operation on the power button 20 is invalid, that is, even if the user presses the power button 20 to shutdown the computer 10, the computer 10 cannot be turned off. The not preventing mode indicates that the power off operation on the power button 20 is valid. That is, if the user presses the power button 20 to shutdown the computer 10, the computer 10 is turned off. The mode setting module 30 is pre-installed in the BIOS (Basic Input Output System) of the computer 10. The initial mode of the computer 10 is set as the preventing power off mode.

The determining module 50 is configured to determine which mode the user sets. The control module 60 is configured to control the switch module 40 to disconnect to prevent the power off signal to be transmitted to the south bridge chip 70 on the basis of the power off signal when the mode of the computer 10 is set as the preventing power off mode, and control the switch module 40 to connect to transmit the power off signal to the south bridge chip 70 on the basis of the power off signal when the mode of the computer 10 is set as the not preventing mode.

In another embodiment, the mode setting module 30 further provides a preventing power on and power off mode. The preventing power on and power off mode indicates that the power on operation and the power off operation on the power button 20 are invalid, that is, even if the user presses the power button 20 to start up or shutdown the computer 10, the computer 10 cannot be turned on or turned off. When the mode of the computer 10 is set as the preventing power on and power off mode, the control module 60 is configured to control the switch module 40 to disconnect to prevent the power off signal to be transmitted to the south bridge chip 70 on the basis of the power off signal, and control the switch module 40 to disconnect to prevent the power on signal to be transmitted to the south bridge chip 70 on the basis of the power on signal. The computer 10 further includes a power detecting module 80. The power detecting module 80 is configured to detect whether the computer 10 is connected to power. The control module 60 is further configured to transmit a power on signal to the south bridge chip 70 when the computer 10 is connected to power.

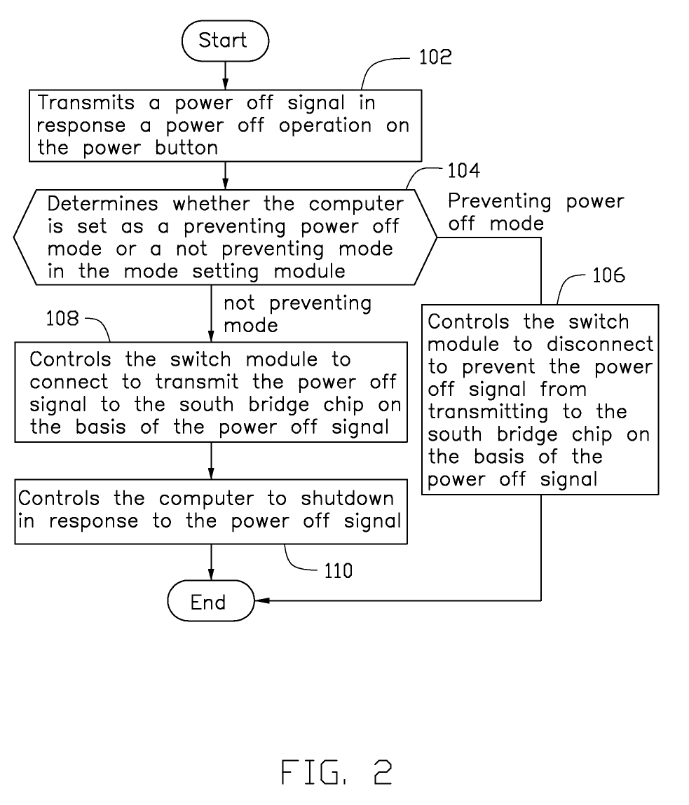

Referring to FIG. 2, a flowchart of a method for preventing error shutdown computer is presented in accordance with an example embodiment. The example method is provided by way of example, as there are a variety of ways to carry out the method. The method described below can be carried out using the configurations illustrated in FIGS. 1 and 2, for example, and various elements of these figures are referenced in explaining example method. Each block shown in FIG. 2 represents one or more processes, methods or subroutines, carried out in the example method. Furthermore, the illustrated order of blocks is illustrative only and the order of the blocks can change according to the present disclosure. Additional blocks can be added or fewer blocks may be utilized, without departing from this disclosure. The example method can begin at block 102.

At block 102, the power button 20 transmits a power off signal in response a power off operation on the power button 20.

At block 104, the determining module 50 determines whether the computer 10 is set as a preventing power off mode or a not preventing mode in the mode setting module 30. If the computer 10 is set as the preventing power off mode, the procedure goes to block 106. If the computer 10 is set as the not preventing mode, the procedure goes block 108. Wherein the mode setting module 30 is pre-installed in the basic input output system (BIOS) of the computer 10.

At block 106, the control module 60 controls the switch module 40 to disconnect to prevent the power off signal from transmitting to the south bridge chip 70 on the basis of the power off signal. Wherein, the switch module 40 connects between the power button 20 and the south bridge chip 70.

At block 108, the control module 60 controls the switch module 40 to connect to transmit the power off signal to the south bridge chip 70 on the basis of the power off signal.

At block 110, the south bridge chip 70 controls the computer 10 to shutdown in response to the power off signal.

The embodiments shown and described above are only examples. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims.

What is claimed is:

1. A computer comprising:
a power button configured to transmit a power on or power off signal in response to a power on or power off operation of the power button to start up or shut down the computer;
a south bridge chip configured to control the computer to start up in response to the power on signal and control the computer to shutdown in response to the power off signal;
a switch module configured to control whether the power on or power off signal is transmitted to the south bridge chip;
a mode setting module configured to provide modes for setting the mode of the computer, the modes comprising a preventing power off mode; and
a control module configured to control the switch module to disconnect to prevent the power off signal to be transmitted to the south bridge chip on the basis of the power off signal when the mode of the computer is set as the preventing power off mode.

2. The computer as claimed in claim 1, wherein the provided modes further comprises a not preventing mode, the control module is further configured to control the switch module to connect to transmit the power off signal to the south bridge chip on the basis of the power off signal when the mode of the computer is set as the not preventing mode.

3. The computer as claimed in claim 2, wherein the initial mode of the computer is set as the preventing power off mode.

4. The computer as claimed in claim 1, wherein the mode setting module is pre-installed in the basic input output system of the computer.

5. The computer as claimed in claim 1, wherein the switch module connects between the power button and the south bridge chip.

6. The computer as claimed in claim 1, wherein the computer is a notebook computer.

7. The computer as claimed in claim 1, wherein the provided mode further comprises a preventing power on and power off mode, when the mode of the computer is set as the preventing power on and power off mode, the control module controls the switch module to disconnect to prevent the power off signal to be transmitted to the south bridge chip on the basis of the power off signal.

8. The computer as claimed in claim 7, wherein when the mode of the computer is set as the preventing power on and power off mode, the control module controls the switch module to disconnect to prevent the power on signal to be transmitted to the south bridge chip on the basis of the power on signal.

9. The computer as claimed in claim 8, wherein the computer further comprises a power detecting module, the power detecting module is configured to detect whether the computer is connected to a power, the control module is further configured to transmit a power on signal to the south bridge chip when the computer is connected to a power.

10. A computer comprising:
a power off button configured to transmit a power off signal in response to a power off operation on the power button to shut down the computer;
a south bridge chip configured to control the computer to shutdown in response to the power off signal;
a switch module configured to control whether the power off signal is transmitted to the south bridge chip;
a mode setting module pre-installed in a basic input output system of the computer and configured to provide a preventing power off mode indicating a power off operation on the power button is invalid;
a control module configured to control the switch module to disconnect to prevent the power off signal to be transmitted to the south bridge chip when the mode of the computer is set as the preventing power off mode.

11. The computer as claimed in claim 10, wherein the mode setting module further provides a not preventing mode indicating a power off operation on the power off button is valid, the control module is further configured to control the switch module to connect to transmit the power off signal to the south bridge chip on the basis of the power off signal when the mode of the computer is set as the not preventing mode.

12. The computer as claimed in claim 11, wherein the initial mode of the computer is set as the preventing power off mode.

13. The computer as claimed in claim 10, wherein the switch module connects between the power off button and the south bridge chip.

14. The computer as claimed in claim 10, wherein the computer is a notebook computer.

15. The computer as claimed in claim 10, wherein the computer further comprises a power on button, the power on button transmits a power on signal in response to a power on operation on the power on button, the control module controls the switch module to connect to transmit the power on signal to the south bridge chip on the basis of the power on signal when the mode of the computer is set as the preventing power off mode, the south bridge chip controls the computer to start up in response to the power on signal.

16. The computer as claimed in claim 15, wherein the provided mode further comprises a preventing power on and power off mode, when the mode of the computer is set as the preventing power on and power off mode, the control module controls the switch module to disconnect to prevent the power on signal to be transmitted to the south bridge chip on the basis of the power on signal.

17. The computer as claimed in claim 16, wherein the computer further comprises a power detecting module, the power detecting module is configured to detect whether the computer is connected to a power, the control module is further configured to transmit a power on signal to the south bridge chip when the computer is connected to a power.

18. A method for preventing error shutdown computer comprising:
transmitting a power off signal in response a power off operation on the power button of a computer;
determining whether the computer is set as a preventing power off mode or a not preventing mode; and
controlling a switch module connecting between the power button and a south bridge chip to disconnect to prevent the power off signal to be transmitted to the south bridge chip on the basis of the power off signal when the computer is set as preventing power off mode.

19. The method as claimed in claim 18, further comprising:
controlling the switch module to connect to transmit the power off signal to the south bridge chip on the basis of the power off signal; and
controlling the computer to shutdown in response to the power off signal through the south bridge chip.

20. The method as claimed in claim 18, wherein the computer is notebook computer.
